(19) United States
(12) Patent Application Publication
(10) Pub. No.: US 2025/0168904 A1
(43) Pub. Date: May 22, 2025

(54) METHOD AND DEVICE FOR DEVICE REGISTRATION MANAGEMENT AND CONTROL

(71) Applicant: Samsung Electronics Co., Ltd., Suwon-si, Gyeonggi-do (KR)

(72) Inventors: Hyunseob OH, Suwon-si (KR); Sungdong KIM, Suwon-si (KR); Jihye LEE, Suwon-si (KR); Sooyeon JUNG, Suwon-si (KR)

(21) Appl. No.: 18/841,437

(22) PCT Filed: Feb. 28, 2023
(86) PCT No.: PCT/KR2023/002803

§ 371 Date: Aug. 26, 2024

(30) Foreign Application Priority Data
Feb. 28, 2022 (KR) 10-2022-0026405

(51) Int. Cl. H04W 76/10; H04L 61/4541; H04L 67/125; H04W 4/80; H04W 8/00

(52) U.S. Cl. CPC H04W 76/10; H04L 61/4541; H04L 67/125; H04W 4/80; H04W 8/005

(57) ABSTRACT

The present disclosure provides a method by which an electronic device uses an auxiliary device in order to initially connect and register an IoT device to an IoT service and control same. The method of the present disclosure may comprise the steps of: setting a tag device and UWB connection; receiving, through the tag device, basic information about an IoT device from the IoT device; discovering the IoT device by using one from among one or more discovery methods on the basis of the basic information; and registering the discovered IoT device to the IoT service.

### CROSS-REFERENCE TO RELATED APPLICATION(S)

This application is a U.S. National Stage application under 35 U.S.C. § 371 of an International application number PCT/KR2023/002803, filed on Feb. 28, 2023, which is based on and claims priority of a Korean patent application number 10-2022-0026405, filed on Feb. 28, 2022, in the Korean Intellectual Property Office, the disclosure of which is incorporated by reference herein in its entirety.

### TECHNICAL FIELD

The disclosure relates to a method and device for registering a device in a service and controlling the same.

### BACKGROUND ART

The Internet is evolving from the human-centered connection network by which humans create and consume information to the Internet of Things (IoT) network by which information is communicated and processed between things or other distributed components. Another arising technology is the Internet of Everything (IoE), which is a combination of the Big data processing technology and the IoT technology through, e.g., a connection with a cloud server. Implementing the IoT requires technical elements, such as sensing technology, a wired/wireless communication and network infrastructure, service interface and security technologies. A recent ongoing research for thing-to-thing connection is on techniques for sensor networking, machine-to-machine (M2M), or machine-type communication (MTC).

In the IoT environment may be offered intelligent Internet Technology (IT) services that collect and analyze the data generated by the things connected with one another to create human life a new value. The IT may have various applications, such as the smart home, smart building, smart city, smart car or connected car, smart grid, health-care, or smart appliance industry, or state-of-art medical services, through conversion or integration of conventional information technology (IT) techniques and various industries.

To use these IoT devices, it is necessary to connect/register the IoT device to the IoT service.

### DETAILED DESCRIPTION OF THE INVENTION

### Technical Problem

The disclosure provides a method for connecting/registering an IoT device in an IoT service and controlling the same.

### Technical Solution

According to various embodiments of the disclosure, a method for connecting an Internet of things (IoT) device to an IoT service and controlling the same using a tag device, by an electronic device may comprise establishing a UWB connection with the tag device, receiving basic information about the IoT device from the IoT device through the tag device, discovering the IoT device using one of at least one discovery scheme based on the basic information, and registering the discovered IoT device in the IoT service.

According to various embodiments of the disclosure, an electronic device for connecting an Internet of things (IoT) device to an IoT service and controlling the same using a tag device may comprise a transceiver and a controller connected to the transceiver. The controller may be configured to establish a UWB connection with the tag device, receive basic information about the IoT device from the IoT device through the tag device, discover the IoT device using one of at least one discovery scheme based on the basic information, and register the discovered IoT device in the IoT service.

### Advantageous Effects

The disclosure provides a method for registering an IoT device in an IoT service and controlling the same using an auxiliary device, thereby efficiently connecting/registering the IoT device.

### BRIEF DESCRIPTION OF DRAWINGS

FIG. 1 is a block diagram schematically illustrating an electronic device;

FIG. 2A illustrates a system for registration management and control of an IoT device according to a first embodiment of the disclosure;

FIG. 2B illustrates a system for registration management and control of an IoT device according to the second embodiment of the disclosure;

FIG. 3A illustrates a BLE connection procedure between a first electronic device and a third electronic device according to the first embodiment of the disclosure;

FIG. 3B illustrates a BLE connection procedure between a first electronic device and a third electronic device according to the second embodiment of the disclosure;

FIG. 4 illustrates a UWB connection procedure between a first electronic device and a third electronic device according to an embodiment of the disclosure;

FIG. 5 illustrates an initial connection and registration procedure of an IoT device according to an embodiment of the disclosure;

FIG. 6 illustrates an initial connection and registration procedure of an IoT device according to another embodiment of the disclosure;

FIG. 7 illustrates an initial connection and registration procedure of an IoT device according to another embodiment of the disclosure;

FIG. 8A illustrates a control procedure of an IoT device according to an embodiment of the disclosure;

FIG. 8B illustrates a control procedure of an IoT device according to another embodiment of the disclosure;

FIG. 9A illustrates a control procedure of an IoT device according to another embodiment of the disclosure;

FIG. 9B illustrates a control procedure of an IoT device according to another embodiment of the disclosure;

FIG. 10 illustrates a control procedure of an IoT device according to another embodiment of the disclosure;

FIG. 11 illustrates a use example of controlling an IoT device using a smart tag according to an embodiment of the disclosure;

FIG. 12 illustrates a method of an electronic device according to an embodiment of the disclosure;

FIG. 13 is a view illustrating a structure of a first electronic device according to an embodiment of the disclosure;

FIG. 14 is a view illustrating a structure of a second electronic device according to an embodiment of the disclosure; and

FIG. 15 is a view illustrating a structure of a third electronic device according to an embodiment of the disclosure.

### MODE FOR CARRYING OUT THE INVENTION

Hereinafter, embodiments of the disclosure are described in detail with reference to the accompanying drawings.

In describing embodiments, the description of technologies that are known in the art and are not directly related to the present invention is omitted. This is for further clarifying the gist of the present disclosure without making it unclear.

For the same reasons, some elements may be exaggerated or schematically shown. The size of each element does not necessarily reflects the real size of the element. The same reference numeral is used to refer to the same element throughout the drawings.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide steps for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments of the disclosure, a “ . . . unit” may include one or more processors.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the present disclosure and may be replaced with other terms according to the intention or practice of the user or operator. Therefore, the terms should be defined based on the overall disclosure.

Hereinafter, embodiments of the present invention are described in detail with reference to the accompanying drawings. When determined to make the subject matter of the present invention unclear, the detailed description of the known art or functions may be skipped. The terms as used herein are defined considering the functions in the present disclosure and may be replaced with other terms according to the intention or practice of the user or operator. Therefore, the terms should be defined based on the overall disclosure.

The terminology used herein is provided for a better understanding of the disclosure, and changes may be made thereto without departing from the technical spirit of the disclosure.

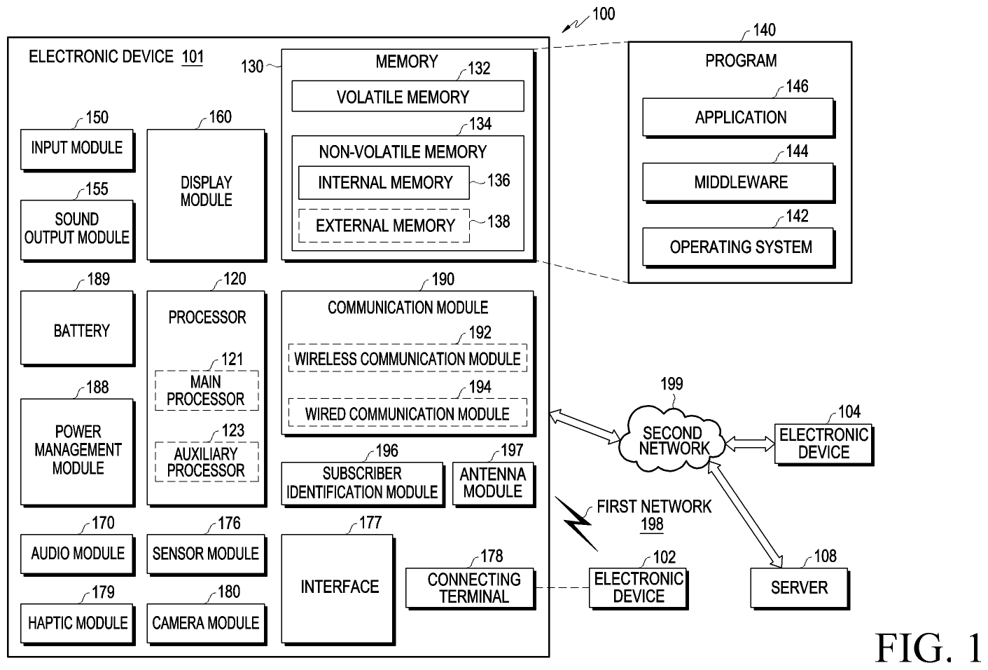

FIG. 1 is a block diagram schematically illustrating an electronic device.

In the embodiment of FIG. 1, the electronic device may correspond to one of a first electronic device (commissioner), a second electronic device (commissionee), a third electronic device (smart tag), or an access point (AP) (Wi-Fi AP), which is described below.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

The electronic device according to various embodiments of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in the form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The disclosure aims to provide a method for providing an advanced user experience (UX) for a UWB/BLE-based onboarding process (device initial connection/registration process) and control, to an IoT device/appliance.

To that end, it is necessary to add the UWB/BLE communication interface to the IoT device while minimizing hardware (H/W) modification and deployment cost.

In an embodiment, an attachable tag device (first type tag device (e.g., SmartTag+)) that supports the UWB/BLE communication interface but does not support the NFC communication interface may be used, as an onboarding agent of the IoT device, to add the UWB/BLE communication interface to the IoT device.

In another embodiment, an NFC-based attachable tag device supporting the UWB/BLE communication interface may be used, as a dongle of an IoT device (second type tag device (e.g., SmartTag++)), to add the UWB/BLE communication interface to the IoT device.

By providing such an advanced UX, the user may perform easier and better onboarding and control for an IoT device.

In the disclosure, an initial connection/registration procedure for the IoT device to be registered may be referred to as commissioning, a commissioning procedure, or an onboarding process/procedure.

Upon initial connection/registration, the basic information about the IoT device (commissionee) is transferred to the electronic device (commissioner) that registers the IoT device, and the basic information may be used for discovery of the IoT device and device connection/registration. In the disclosure, the basic information about the IoT device may be referred to as device connection information and device registration information.

As an embodiment, the basic information about the IoT device may include, e.g., information about the product ID, the passcode, and/or the discovery scheme supported by the IoT device.

As an embodiment, the basic information about the IoT device may be included in an onboarding payload. The onboarding payload is information/data including basic information about the IoT device, and may be provided in the form of, e.g., a QR code, an NFC tag, or a numeric code (e.g., an 11-digit or 21-digit numeric code (e.g., a manual pairing code of 11 (or 21) digits)). The onboarding payload may be provided, e.g., in the form of a sticker attached to the commissionee device or in the form of being displayed on the display of the IoT device. Accordingly, the basic information about the IoT device may be provided to the electronic device which registers the IoT device, and may be used for initial connection/registration.

As an embodiment, the initial connection procedure of the IoT device may include a device connection information acquisition procedure (onboarding payload acquisition procedure), a device discovery procedure, and/or a device connection/registration procedure.

As an embodiment, the onboarding payload may be obtained by scanning the QR code of the IoT device, reading the NFC tag of the IoT device, or inputting the numeric code of the IoT device.

As an embodiment, the discovery of the IoT device may be performed using a domain name service (DNS)-service discovery (SD) scheme, a Bluetooth low energy (BLE) discovery scheme, and/or a software enabled access point (Soft-AP) discovery scheme.

As an embodiment, device connection/registration may include at least one operation for device verification and/or IoT service connection/registration.

Meanwhile, IoT devices mainly provide only limited communication functions such as Wi-Fi communication functions. Hereinafter, various embodiments for efficient initial input/registration (commissioning) and control of an IoT device using a tag device having a UWB/BLE communication function are described with reference to each drawing.

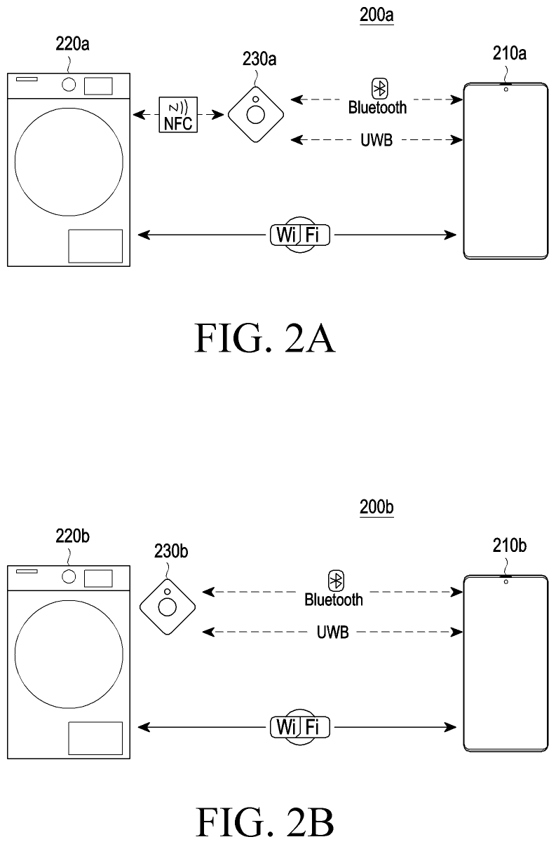

### [System for Registration Management and Control of IoT Device (Embodiment of FIG. 2)]

### <First Example of System for Registration Management and Control of IoT Device>

The first embodiment may be an embodiment in which a system for registration management and control of an IoT device includes an auxiliary device (third electronic device) that supports not only communication with a commissioner (first electronic device) but also communication with a commissionee (second electronic device) which is to be registered. For example, the system of the first embodiment may be a system including a tag device (e.g., SmartTag++ (second type smart tag)), as a third electronic device, supporting an NFC interface with the second electronic device, together with a UWB interface and/or a BLE interface with the first electronic device. As an embodiment, the second type smart tag may be a dongle of an NFC-based attachable and rechargeable IoT device.

In the first embodiment, the NFC interface may be supported by the second electronic device and the third electronic device to use the dongle. As an embodiment, the third electronic device may perform NFC-based recharging using the NFC wireless charging specification through the NFC interface.

In the first embodiment, a metal part for the second electronic device and a magnetic cover for the third electronic device need to be added near the NFC interface area. Alternatively, in order to catch the third electronic device, it is necessary to form a sufficient gap for the second electronic device near the NFC interface.

FIG. 2A illustrates a system for registration management and control of an IoT device according to a first embodiment of the disclosure.

Referring to FIG. 2A, a system 200a for registration management and control of IoT devices (hereinafter, referred to as a “system”) may include a first electronic device 210a, a second electronic device 220a, and a third electronic device 230a.

The first electronic device 210a may be an electronic device for connecting/registering the second electronic device 220a to a specific service/platform. For example, as illustrated, the first electronic device 210a may be an electronic device such as a smartphone for connecting/registering the second electronic device 220a to an IT service/platform and controlling the same, but is not limited thereto, and various types of electronic devices such as a voice assistant or a TV may be used as the first electronic device 210a.

As an embodiment, the first electronic device 210a may support at least one communication function (e.g., Wi-Fi communication function/interface) for communication with the second electronic device 220a and at least one communication function (e.g., UWB communication function/interface and/or BLE communication function/interface) for communication with the third electronic device 230a. As an embodiment, the first electronic device 210a may include an IoT service/platform.

In the disclosure, the first electronic device 210a may be referred to as a commissioner, a commissioner device/apparatus, a registration subject device/apparatus, a controller, a controller device/apparatus, or the like.

The second electronic device 220a may be an electronic device subject to connection/registration for a specific service/platform. For example, the second electronic device 220a may be an electronic device (IoT device) such as a washing machine (WM) to be connected/registered to an IoT service/platform, but is not limited thereto, and various types of IoT devices such as smart light bulbs and door locks may be used as the second electronic device 220a.

As an embodiment, the second electronic device 220a may support at least one communication function (e.g., Wi-Fi communication function/interface) for communication with the first electronic device 210a and at least one communication function (e.g., NFC communication function/interface) for communication with the third electronic device 230a.

In the disclosure, the second electronic device 220a may be referred to as a commissionee, a commissionee device/apparatus, an IoT device/apparatus, a smart home device/apparatus, a registration target device/apparatus, a controllee, a controllee device/apparatus, or the like.

The third electronic device 230a may be an electronic device for assisting connection/registration and/or control of the second electronic device 220a. In the embodiment of FIG. 2A, in order to assist connection/registration and/or control of the second electronic device 220a, the third electronic device 230a may support at least one communication function (e.g., NFC communication function/interface) for communication with the second electronic device 220a, together with at least one communication function (e.g., UWB communication function/interface and/or BLE communication function/interface) for communication with the first electronic device 210a. For example, as illustrated, the third electronic device 230a may be a tag device (e.g., SmartTag++ (second type smart tag)) supporting an NFC communication function/interface together with a UWB communication function/interface and a BLE communication function/interface, but is not limited thereto. In the disclosure, the third electronic device 230a may be referred to as SmartTag++, a second type tag, a second type tag device/apparatus, a second type smart tag, a second type smart tag device/apparatus, and a second type auxiliary device/apparatus.

Meanwhile, in the embodiment of FIG. 2A, the AP network for IoT service/platform connection may be, e.g., a Wi-Fi network, but is not limited thereto.

### <Second Example of System for Registration Management and Control of IoT Device>

Unlike the first embodiment, the second embodiment may be an embodiment in which a system for registration management and control of an IoT device includes an auxiliary device that only supports communication with a registration subject device (commissioner) but does not support communication with a registration target device (commissionee). For example, the system of the second embodiment may be a system including a tag device (e.g., SmartTag+ (first type smart tag)), as an auxiliary device, that supports a UWB interface and/or a BLE interface with the commissioner but does not support an NFC interface with the commissionee. As an embodiment, the first type smart tag may operate as a UWB/BLE-based onboarding agent.

In the second embodiment, a metal part for the second electronic device and a magnetic cover for the third electronic device need to be added near the NFC interface area. Alternatively, in order to catch the third electronic device, it is necessary to form a sufficient gap for the second electronic device near the NFC interface.

FIG. 2B illustrates a system for registration management and control of an IoT device according to the second embodiment of the disclosure.

Referring to FIG. 2B, a system 200b for registration management and control of IoT devices (hereinafter, referred to as a “system”) may include a first electronic device 210b, a second electronic device 220b, and a third electronic device 230b.

The first electronic device 210b may be an electronic device for connecting/registering the second electronic device 220b to a specific service/platform. For example, as illustrated, the first electronic device 210b may be an electronic device such as a smartphone for connecting/registering the second electronic device 220b to an IoT service/platform and controlling the same, but is not limited thereto, and various types of electronic devices such as a voice assistant or a TV may be used as the first electronic device 210b.

As an embodiment, the first electronic device 210b may support at least one communication function (e.g., a Wi-Fi communication function/interface) for communication with the second electronic device 220b and at least one communication function (e.g., a UWB communication function/interface and/or a BLE communication function/interface) for communication with the third electronic device 230b. As an embodiment, the first electronic device 210b may include an IoT service/platform.

In the disclosure, the first electronic device 210b may be referred to as a commissioner, a commissioner device/apparatus, a registration subject device/apparatus, a controller, a controller device/apparatus, or the like.

The second electronic device 220b may be an electronic device subject to connection/registration for a specific service/platform. For example, the second electronic device 220b may be an electronic device (IoT device) such as a washing machine (WM) to be connected/registered to an IoT service/platform, but is not limited thereto, and various types of IoT devices such as a smart light bulb, a TV, and a door lock may be used as the second electronic device 220b.

As an embodiment, the second electronic device 220b may support at least one communication function (e.g., a Wi-Fi communication function/interface) for communication with the first electronic device 210b.

In the disclosure, the second electronic device 220b may be referred to as a commissionee, a commissionee device/apparatus, an IoT device/apparatus, a smart home device/apparatus, a registration target device/apparatus, a controllee, a controllee device/apparatus, or the like.

The third electronic device 230b may be an electronic device for assisting connection/registration and/or control of the second electronic device 220b. In the embodiment of FIG. 2B, in order to assist connection/registration and/or control of the second electronic device 220b, the third electronic device 230b may support at least one communication function (e.g., UWB communication function and/or BLE communication function) for communication with the first electronic device 210a. For example, as illustrated, the third electronic device 230b may be a tag device (e.g., SmartTag+ (first type smart tag)) supporting a UWB communication function/interface and a BLE communication function/interface, but is not limited thereto. In the disclosure, the third electronic device 230b may be referred to as SmartTag+, a first type tag, a first type tag device/apparatus, a first type smart tag, a first type smart tag device/apparatus, and a first type auxiliary device/apparatus.

Meanwhile, in the embodiment of FIG. 2B, the AP network for IoT service/platform connection may be, e.g., a Wi-Fi network, but is not limited thereto.

Hereinafter, various embodiments supporting an advanced onboarding process (IoT device initial connection/registration procedure) and a control UX are described. Hereinafter, for convenience of description, various embodiments are described with reference to an example in which a third electronic device operating as an auxiliary device for supporting an advanced onboarding process and a control UX is a first type smart tag SmartTag+ that does not support an NFC interface or a second type smart tag SmartTag++ that supports an NFC interface. However, the disclosure is not limited thereto, and an electronic device performing the same or similar function may be used as the third electronic device.

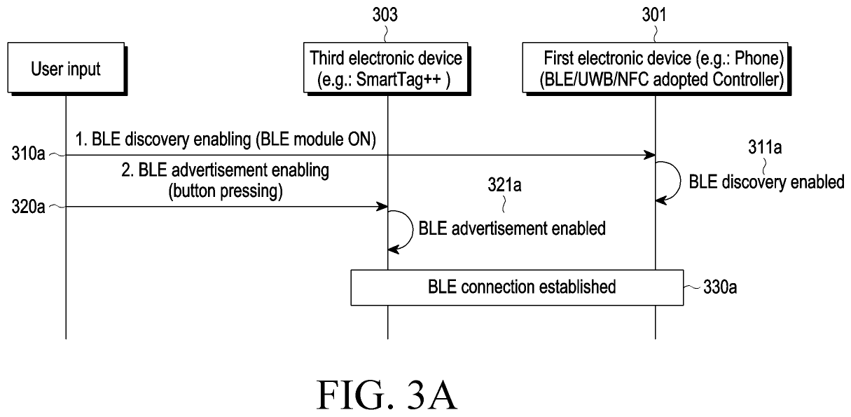

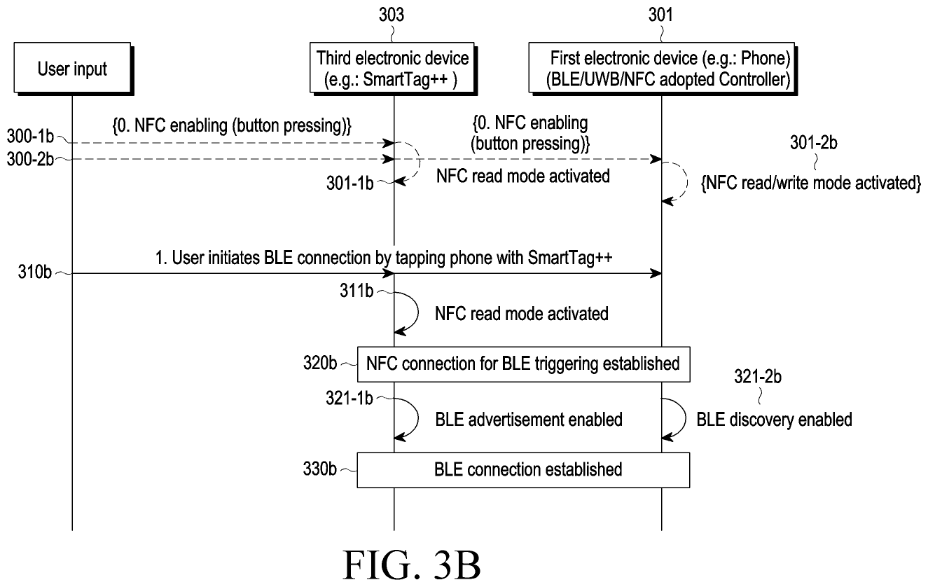

### [BLE Connection Procedure Between First and Third Electronic Devices (Embodiment of FIG. 3)]

### <First Embodiment of BLE Connection Procedure Between First Electronic Device and Third Electronic Device>

The first embodiment may be, e.g., an embodiment of a button-based BLE connection in the second type smart tag SmartTag++.

FIG. 3A illustrates a BLE connection procedure between a first electronic device and a third electronic device according to the first embodiment of the disclosure.

In the embodiment of FIG. 3A, the first electronic device 301 may be the first electronic device 210a of FIG. 2A, and the third electronic device 303 may be the third electronic device 230a of FIG. 2A.

Referring to FIG. 3A, in operation 310a, the first electronic device 301 may receive a user input for activating a BLE discovery function (or a BLE module). In operation 311a, the first electronic device 301 may activate a BLE discovery function (or BLE module) in response to a user input.

In operation 320a, the third electronic device 303 may receive a user input for activating a BLE advertisement function. In operation 321a, the third electronic device 303 may activate the BLE advertisement function in response to a user input.

In operation 330a, the first electronic device 301 and the third electronic device 303 may establish a BLE connection between the first electronic device 301 and the third electronic device 303 using a preset method. Accordingly, the BLE connection between the first electronic device 301 and the third electronic device 303 may be activated.

Meanwhile, unlike the illustrated embodiment, according to an embodiment, operation 320a/321a may be performed before operation 310a/311a.

Meanwhile, the embodiment of FIG. 2A may also be used in a system using a first type smart tag SmartTag+.

### <Second Embodiment of BLE Connection Procedure Between First Electronic Device and Third Electronic Device>

The second embodiment may be an embodiment of NFC-based BLE connection of the second type smart tag SmartTag++.

FIG. 3B illustrates a BLE connection procedure between a first electronic device and a third electronic device according to the second embodiment of the disclosure.

In the embodiment of FIG. 3B, the first electronic device 301 may be the first electronic device 210a of FIG. 2A, and the third electronic device 303 may be the third electronic device 230a of FIG. 2A. For example, the first electronic device 301 may be the user's smartphone, and the third electronic device 303 may be a second type smart tag SmartTag++, but embodiments are not limited thereto.

Referring to FIG. 3B, in operation 300-1b, the third electronic device 303 may receive a user input (e.g., a button input) for activating an NFC function (or an NFC module). In operation 301-1b, the third electronic device 303 may activate an NFC read mode in response to a user input.

In operation 300-2b, the first electronic device 301 may receive a user input for activating an NFC function (or an NFC module). In operation 301-2b, the first electronic device 301 may activate an NFC read/write mode in response to a user input.

Meanwhile, unlike the illustrated embodiment, according to an embodiment, operation 300-2b/301-2b may be performed before operation 300-1b/301-1b. Further, the NFC activation operation by operation 300-1b/301-1b is an optional operation, and may not be performed according to an embodiment.

In operation 310b, the user may tap the third electronic device 303 to the first electronic device 301 to initiate the BLE connection, and the first electronic device 301 and the second electronic device 303 may identify/obtain an operation (user input) of tapping the third electronic device 303 to the first electronic device 301. In operation 311b, the third electronic device 303 may activate an NFC read mode, based on a user input. Meanwhile, when the NFC read mode is already activated in operation 301-1b, operation 311b may be omitted.

In operation 320b, the first electronic device 301 and the third electronic device 303 may establish an NFC connection between the first electronic device 301 and the third electronic device 303 for BLE triggering using a preset method.

In operation 321-1b, the third electronic device 303 may activate the BLE advertisement function. In operation 321-1b, the first electronic device 301 may activate a BLE discovery function (or BLE module). As described above, unlike the first embodiment in which the BLE advertisement/BLE discovery function is activated in response to the user input, in the second embodiment, when the NFC connection for BLE triggering is established, the BLE advertisement/BLE discovery function may be automatically activated.

In operation 330b, the first electronic device 301 and the third electronic device 303 may establish a BLE connection between the first electronic device 301 and the third electronic device 303 using a preset method.

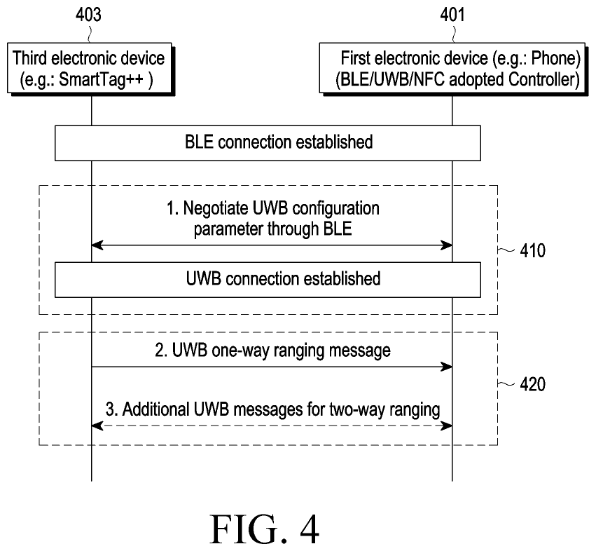

### [UWB Connection Procedure Between First Electronic Device and Third Electronic Device (Embodiment of FIG. 4)]

FIG. 4 illustrates a UWB connection procedure between a first electronic device and a third electronic device according to an embodiment of the disclosure.

In the embodiment of FIG. 4, the first electronic device 401 may be the first electronic device 210a of FIG. 2A, and the third electronic device 403 may be the third electronic device 230a of FIG. 2A. For example, the first electronic device 401 may be the user's smartphone, and the third electronic device 403 may be a second type smart tag SmartTag++, but embodiments are not limited thereto.

In the embodiment of FIG. 4, it is assumed that the BLE connection between the first electronic device 401 and the third electronic device 403 is established before the UWB connection is established. The BLE connection between the first electronic device 401 and the third electronic device 403 may be performed, e.g., according to the embodiment of FIG. 3A or 3B. However, according to an embodiment, the BLE connection between the first electronic device 401 and the third electronic device 403 may not be established before the UWB connection is established.

Referring to FIG. 4, the UWB connection procedure may include a UWB connection establishment step 410 and a UWB ranging step 420.

The UWB connection establishment step 410 may include operation 1 as follows.

In operation 1, the first electronic device 401 may negotiate the UWB configuration parameter through the BLE connection established with the third electronic device 403. The UWB connection may be established based on the so negotiated UWB configuration parameter.

The UWB ranging step 420 may include operation 2 and/or operation 3 as follows.

In operation 2, the first electronic device 401 may receive a UWB message (OWR message) for one-way ranging (OWR) from the third electronic device 403.

Accordingly, the first electronic device 401 may obtain UWB-based information. As an embodiment, the UWB-based information may include at least one of ranging information (e.g., distance information) between the first electronic device 401 and the third electronic device 403, angle of arrival (AoA) information, or localization information. In an embodiment, when the UWB message may be received from the at least two third electronic devices 403 and location information (e.g., absolute location coordinates) about the third electronic device 403 may be obtained, the first electronic device 401 may calculate its own location. In other words, localization information may be obtained.

As an embodiment, the UWB message (OWR message) for OWR may include an onboarding payload of the IoT device (second electronic device) to be registered. For example, the onboarding payload may be included in a UWB message (UWB advertisement message) for advertisement among OWR messages.

Table 1 below may be an example of the payload information element (IE) of the UWB advertisement message.

TABLE 1

| | Size | | |
|---|---|---|---|
| Parameter | (bits) | Notes | M/O/C |
| Vendor OUI | 24 | 0x5A18FF | M |
| UWB message ID | 4 | 0x7 = OWR Message | M |
| OWR Message Type | 2 | 0 - Advertisement message | M |
| RFU | 2 | RFU | M |
| Message control | 8 | Configuration of the message | M |
| Interval | 16 | The interval of two consecutive ranging block | CM |
| | | in the units of “ms”. | (only if OWR |
| | | The value is equivalent to the interval of | Message |
| | | two consecutive OWR messages if | Type == 02 |
| | | Random Interval is 0. | |
| Frame Number | 32 | OWR Message Number | M |
| Device Specific Data | N | Device Specific Data as defined in Table xx3 | O |
| Application Payload Data | M | Application Payload Data as defined in Table 2 | O |

Referring to Table 1, the UWB advertisement message may include a UWB message ID field set to a value (e.g., 0x7) indicating the OWB message and an OWR message type field set to a value (e.g., 0) indicating the advertisement message.

The UWB advertisement message may further include an application payload data field including application payload data.

An example of the application payload data field may be as shown in Table 2 below.

TABLE 2

| Parameter | Size (Octet) | Notes |
|---|---|---|
| Payload Data Size | 0/2 | Size of the Application Payload Data |
| Payload Data | 0/N | Payload Data sent by Application layer |

Referring to Table 2, the application payload data field may include a payload data size field indicating the size of the application payload data and a payload data field including payload data provided by the application layer.

As an embodiment, the onboarding payload may be included in the payload date field in the application payload data field of the UWB advertisement message.

As an embodiment, the UWB advertisement message may be transmitted through the UWB MAC frame defined in the IEEE 802.15.4/4z and/or FiRa standard. As an embodiment, the UWB MAC frame may include a MAC header MHR, a MAC payload, and/or a MAC footer MFR.

Table 3 below shows an example of the MAC header MHR.

TABLE 3
MAC Header (MHR)

| | | | | | | | | |
|---|---|---|---|---|---|---|---|---|
| Frame | Source | Auxiliary | Vendor | FiRa | Padding | Session | STS | Header |
| Control | Address | Security | Specific | OUI | | ID | index | Termination |
| | | Header | Header IE | | | | | 1 IE |

Referring to Table 3, the MAC header may include a Frame Control field, a Sequence Number field, a Source Address field, an Auxiliary Security Header field, and/or at least one Header IE field (vendor specific Header IE). According to an embodiment, some fields may not be included in the MAC header.

As an embodiment, the Frame Control field may include a Frame type field, a Security Enabled field, a Frame Pending field, an AR field, a PAN ID Compression field, a Sequence Number Suppression field, an IE Present field, a Destination Addressing Mode field, a Frame Version field, and/or a Source Addressing Mode field. Each field is described below.

The Frame Type field may indicate the frame type. As an embodiment, the frame type may include a data type and/or a multipurpose type.

The Security Enabled field may indicate whether an Auxiliary Security Header field exists. The Auxiliary Security Header field may include information required for security processing.

The Frame Pending field may indicate whether the device transmitting the frame has more data for the recipient. In other words, the Frame Pending field may indicate whether there is a pending frame for the recipient.

The AR field may indicate whether acknowledgment for frame reception is required from the recipient.

The PAN ID Compression field may indicate whether the PAN ID field exists.

The Sequence Number Suppression field may indicate whether the Sequence Number field exists. The Sequence Number field may indicate the sequence identifier for the frame.

The IE Present field may indicate whether the Header IE field and the Payload IE field are included in the frame.

The Destination Addressing Mode field may indicate whether the Destination Address field may include a short address (e.g., 16 bits) or an extended address (e.g., 64 bits). The Destination Address field may indicate the address of the recipient of the frame.

The Frame Version field may indicate the frame version. For example, the Frame Version field may be set to a value indicating IEEE std 802.15.4z-2020.

The Source Addressing Mode field may indicate whether the Source Address field exists, and if the Source Address field exists, whether the Source Address field includes a short address (e.g., 16 bits) or an extended address (e.g., 64 bits). The Source Address field may indicate the address of the originator of the frame.

Table 4 below illustrates an example of MAC payload/MAC footer.

TABLE 4
MAC payload

| | | |
|---|---|---|
| Vendor | Payload IE (Table 1) | FCS |
| Specific | | |
| Nested IE | | |

Referring to Table 4, the MAC payload may include at least one Payload IE field. As an embodiment, the Payload IE field may include a Vendor Specific Nested IE. As an embodiment, the Payload IE field may include the Payload IE field of the UWB message, ranging message or control message. For example, the Payload IE field may include the payload IE of the UWB advertisement message of Table 1 described above.

The MAC footer may include an FCS field. The FCS field may include a 16-bit CRC or a 32-bit CRC.

In operation 3, the first electronic device 401 may exchange an additional UWB message (TWR message) for two-way ranging with the second electronic device 403. Accordingly, the first electronic device 401 may obtain UWB-based information. As an embodiment, the UWB-based information may include at least one of ranging information (e.g., distance information) between the first electronic device 401 and the third electronic device 403, angle of arrival (AoA) information, or localization information.

Meanwhile, the operation for two-way ranging in operation 3 is an optional operation, and may be performed together with or instead of the operation for one-way ranging in operation 421, but may be omitted according to an embodiment. Whether to perform operation 3 may be determined based on the UWB configuration parameter negotiated through BLE in operation 1. For example, whether to perform two-way ranging may be determined based on the value of the field indicating the ranging method in the UWB configuration parameter.

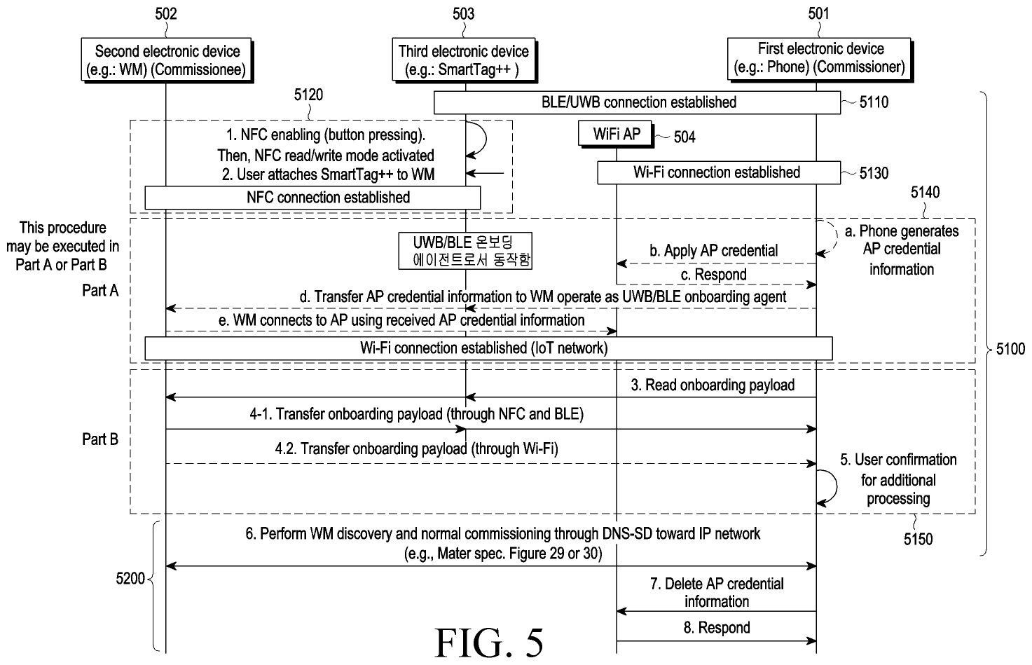

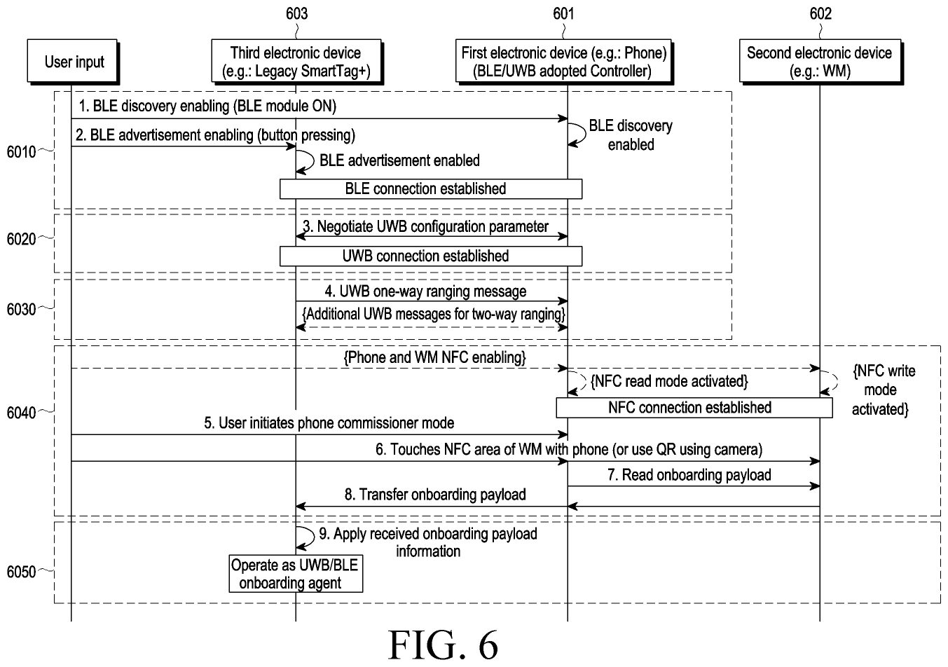

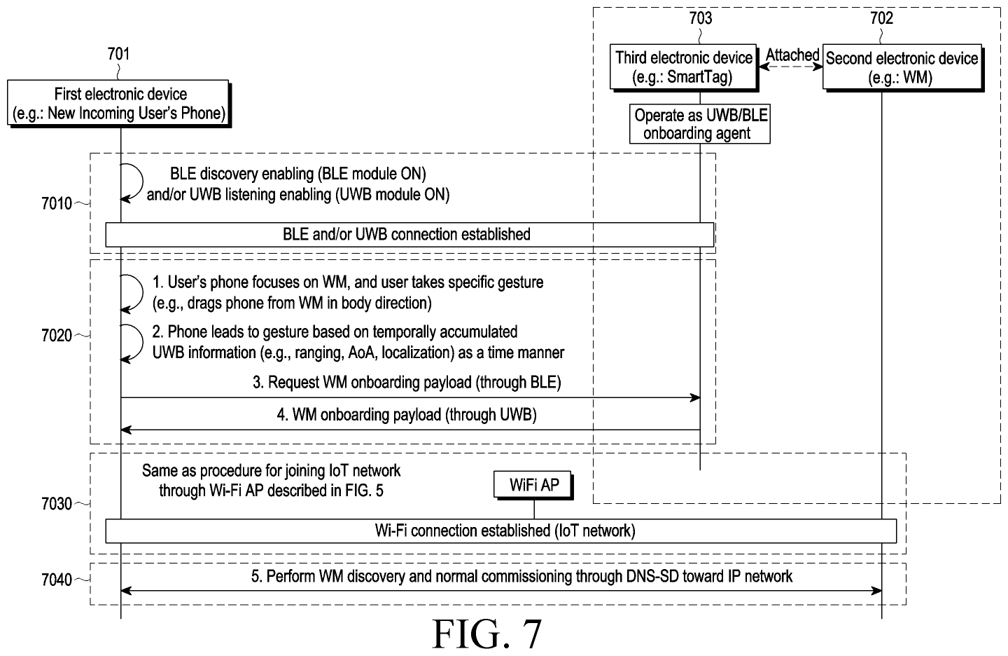

### [Initial Connection and Registration Procedure of IoT Device (Embodiment of FIGS. 5 to 7)]

FIG. 5 illustrates an initial connection and registration procedure of an IoT device according to an embodiment of the disclosure.

In the embodiment of FIG. 5, the first electronic device 501 may be the first electronic device 210a of FIG. 2A, the second electronic device 502 may be the second electronic device 220a of FIG. 2A, and the third electronic device 503 may be the third electronic device 230a of FIG. 2A. For example, the first electronic device 501 may be the user's smartphone, the second electronic device 502 may be a washing machine WM, and the third electronic device 503 may be a second type smart tag SmartTag++, but embodiments are not limited thereto.

Referring to FIG. 5, an initial connection and registration procedure (onboarding procedure) of an IoT device may include an onboarding payload acquisition step S100 and a commissioning step S200.

### <Onboarding Payload Acquisition Step S100>

Step S100 is a step for the first electronic device 501 to obtain an onboarding payload from the second electronic device 502, and may include at least one of the following operations/procedures. According to an embodiment, some operations/procedures of step S100 may be omitted, additional operations/procedures may be further performed, or operations/procedures may be performed in an order different from the disclosed order.
Procedure 5110: Procedure 5110 may be a procedure for establishing a BLE/UWB connection between the first electronic device 501 and the third electronic device 503. An example of procedure 5110 is the same as the example described with reference to FIGS. 3 to 4. Accordingly, a BLE/UWB connection between the first electronic device 501 and the third electronic device 503 may be established.
Procedure 5120: Procedure 5120 may be a procedure for establishing an NFC connection between the second electronic device 502 and the third electronic device 503.

As an embodiment, procedure 5120 may include an operation (operation 1) in which the third electronic device 503 activates the NFC function and activates the NFC read/write mode, and an operation (operation 2) in which it is recognized that the third electronic device 503 is attached to the second electronic device 502. Based on operations 1 and 2, an NFC connection between the second electronic device 502 and the third electronic device 503 may be established.
Procedure 5130: Procedure 5130 may be a procedure for establishing a Wi-Fi connection between the first electronic device 501 and the Wi-Fi AP 504.
Procedure 5140: Procedure 5140 may be a procedure for establishing a Wi-Fi connection between the second electronic device 502 and the Wi-Fi AP 504. In procedure 5140, the third electronic device 503 may operate as a UWB/BLE-based onboarding agent. As an embodiment, when the UWB/BLE connection between the first electronic device 501 and the second electronic device 502 is established, the third electronic device 503 may operate as a UWB/BLE-based onboarding agent.

Meanwhile, according to an embodiment, procedure 5140 may be performed after procedure 5150 to be described below. For example, procedure 5140 may be performed within the commissioning step S200. In this case, the operation of obtaining the onboarding payload through Wi-Fi in procedure 5150 to be described below may not be performed.

As an embodiment, procedure 5140 may include an operation (operation a) in which the first electronic device 510 generates AP credential information (network connection information) for commissioning, an operation (operation b) in which the first electronic device 501 transmits a request for applying AP credential information to the Wi-Fi AP 504 to the Wi-Fi AP 504, an operation (operation c) in which the first electronic device 501 receives a response corresponding to the request of operation b from the Wi-Fi AP 504, an operation (operation d) in which the first electronic device 501 transfers AP credential information to the second electronic device 502 through the third electronic device 503, and/or an operation (operation e) in which the second electronic device 502 connects to the Wi-Fi AP 504 using the received AP credential information. Accordingly, a Wi-Fi connection between the second electronic device 502 and the Wi-Fi AP 504 may be established. In other words, the second electronic device 502 may be connected to the IoT network. As an embodiment, the AP credential information may include a service set identifier (SSID) and/or a password for commissioning.
Procedure 5150: Procedure 5150 may be a procedure for the first electronic device 501 to obtain an onboarding payload from the second electronic device 502.

### (First Embodiment of Procedure 5150 (Acquisition of Onboarding Payload Through NFC/BLE))

In a first embodiment, the first electronic device 501 may perform an operation of transferring a request for obtaining the onboarding payload to the second electronic device 502 through the third electronic device 503 (operation 3), an operation of receiving the onboarding payload from the second electronic device 502 through the third electronic device 503 (operation 4-1) and/or an operation in which the first electronic device 501 obtains user confirmation for additional processing (operation 5).

As an embodiment, operation 3 may include an operation in which the first electronic device 501 transmits a request for obtaining an onboard payload through a BLE connection to the third electronic device 503 and an operation in which the third electronic device 503 transmits a request (“Read onboard payload” request) for obtaining an onboard payload through an NFC connection to the second electronic device 502.

As an embodiment, operation 4-1 may include an operation in which the second electronic device 502 transmits the onboarding payload to the third electronic device 503 through the NFC connection and an operation in which the third electronic device 503 transmits the onboarding payload received through the BLE connection to the third electronic device 503.

### (Second Embodiment of Procedure 5150 (Acquisition of Onboarding Payload Through Wi-Fi))

In a second embodiment, the first electronic device 501 may perform an operation of transferring a request for obtaining the onboarding payload to the second electronic device 502 through the third electronic device 503 (operation 3), an operation of receiving the onboarding payload from the second electronic device 502 through the Wi-Fi AP 504 (operation 4-2), and/or an operation in which the first electronic device 501 obtains user confirmation for additional processing (operation 5).

The first embodiment and the second embodiment of procedure 5150 may be selectively performed.

Meanwhile, the second embodiment of procedure 5150 may be performed only when procedure 5140 is performed before procedure 5150. However, the first embodiment of procedure 5150 may be performed regardless of whether procedure 5140 is performed before procedure 5150.

### <Commissioning Step S200>

The commissioning step S200 is a step for the first electronic device 501 to discover and initially connect/register the second electronic device 502, and may include at least one of the following operations/procedures. According to an embodiment, some operations/procedures of step S200 may be omitted, additional operations/procedures may be further performed, or operations/procedures may be performed in an order different from the disclosed order.

Step S200 may include an operation (operation 6) in which the first electronic device discovers the second electronic device 502 using a domain name service (DNS)-service discovery (SD) discovery scheme and performs commissioning.

As an embodiment, operation 6 may be performed using a predefined method (e.g., a method defined in Matter specification).

For example, commissioning may include at least one of a password verification operation (first operation) between the first electronic device 501 and the second electronic device 502, an operation (second operation) in which the first electronic device 501 verifies the second electronic device 502, an operation (third operation) in which the first electronic device 501 transfers network connection information (e.g., an AP credential) to the second electronic device 502, an operation (fourth operation) in which the second electronic device 502 connects to a network (e.g., a Wi-Fi network) using network connection information (e.g., an AP credential), or an operation (fifth operation) in which the first electronic device 501 completes the registration and network connection of the second electronic device 502. Meanwhile, when the Wi-Fi connection between the second electronic device 501 and the Wi-Fi AP 504 is performed before the commissioning step 520, the third operation and the fourth operation described above may be omitted.

As an embodiment, when the Wi-Fi connection between the second electronic device 501 and the Wi-Fi AP 504 is not performed before the commissioning step 520, the first electronic device 501 may discover the second electronic device 502 using a BLE discovery scheme or a software enabled access point (Soft-AP) discovery scheme.

In an embodiment, operation 520 may further include an operation (operation 7) in which the first electronic device 501 transmits a request for deleting AP credential information to the Wi-Fi AP 504 and an operation (operation 8) in which the first electronic device 501 receives a response of operation 7 from the Wi-Fi AP 504. Accordingly, AP credential information for commissioning stored in the Wi-Fi AP 504 may be deleted.

FIG. 6 illustrates an initial connection and registration procedure of an IoT device according to another embodiment of the disclosure.

In the embodiment of FIG. 6, the first electronic device 601 may be the first electronic device 210b of FIG. 2B, the second electronic device 602 may be the second electronic device 220b of FIG. 2B, and the third electronic device 603 may be the third electronic device 230b of FIG. 2B. For example, the first electronic device 601 may be a user's smartphone, the second electronic device 602 may be a washing machine WM, and the third electronic device 603 may be a first type smart tag SmartTag+, but embodiments are not limited thereto.

Referring to FIG. 6, the initial connection and registration procedure of the IoT device may include at least one of the following operations/procedures. According to an embodiment, some operations/procedures may be omitted, additional operations/procedures may be further performed, or operations/procedures may be performed in a different order from the disclosed order.

### <BLE Connection Establishment Procedure 6010>

The BLE connection establishment procedure 6010 may include operation 1 and/or operation 2 as follows.
Operation 1: In operation 1, the first electronic device 601 may receive a user input for activating a BLE discovery function (or BLE module). In response to this user input, the BLE discovery function (or BLE module) may be activated in the first electronic device 601.
Operation 2: In operation 2, the third electronic device 603 may receive a user input for activating a BLE advertisement function. In response to this user input, the BLE advertisement function may be activated in the third electronic device 603.

Through operations 1 and 2, a BLE connection between the first electronic device 601 and the third electronic device 603 may be established.

### <UWB Connection Establishment Procedure 6020>

The UWB connection establishment procedure 6020 may include operation 3 as follows.

Operation 3: In operation 3, the first electronic device 601 may negotiate the UWB configuration parameter through the BLE connection established with the third electronic device 603. The UWB connection between the first electronic device 601 and the third electronic device 603 may be established based on the negotiated UWB configuration parameter.

### <UWB Ranging Procedure 6030>

The UWB ranging procedure 6030 may perform the next operation 4 for one-way ranging (OWR) and/or two-way ranging (TWR) according to the set ranging method.

Operation 4: In operation 4, when the ranging method is a one-way ranging method, the first electronic device 601 may receive a UWB message for one-way ranging from the third electronic device 603. Alternatively, when the ranging method is a two-way ranging method, the first electronic device 601 may exchange a UWB message (additional UWB message) for two-way ranging with the third electronic device 603. Accordingly, the first electronic device 601 may obtain UWB-based information.

As an embodiment, the UWB-based information may include at least one of ranging information (e.g., distance information) between the first electronic device 401 and the third electronic device 403, angle of arrival (AoA) information, or localization information. In an embodiment, when the UWB message may be received from the at least two third electronic devices 403 and location information (e.g., absolute location coordinates) about the third electronic device 403 may be obtained, the first electronic device 401 may calculate its own location.

### <Onboarding Payload Acquisition Step 6040>

The onboarding payload acquisition procedure 6040 may include at least one of the following operations 5 to 8.

Operation 5: In operation 5, the first electronic device 601 may receive a user input for starting the commissioning mode in the first electronic device 601.

Meanwhile, before operation 5 or before operation 6 to be described below, an operation for establishing an NFC connection between the first electronic device 601 and the second electronic device 602 may be further performed. As an embodiment, the operation for establishing the NFC connection between the first electronic device 601 and the second electronic device 602 may include receiving a user input for activating the NFC function by each of the first electronic device 601 and the second electronic device 602, activating the NFC write mode by the first electronic device 601, and activating the NFC read mode by the second electronic device 602. The operation for establishing the NFC connection between the first electronic device 601 and the second electronic device 602 may be an optional operation.

Operation 6: In operation 6, the first electronic device 601 may identify that the first electronic device 601 touches/taps the NFC area of the second electronic device 602. Alternatively, the first electronic device 601 may scan the QR code of the second electronic device 602 through the camera.

Operation 7: In operation 7, the first electronic device 601 may transmit a request for reading the onboarding payload (“Read onboarding payload” request) to the second electronic device 602. As an embodiment, when it is identified that the first electronic device 601 touches/taps the NFC area of the second electronic device 602, the first electronic device 601 may transmit a request (“Read onboarding payload” request) for reading the onboarding payload to the second electronic device 602. Meanwhile, when the first electronic device 601 scans the QR code of the second electronic device 602 through the camera, the onboarding payload may be obtained through the QR code scan, and thus operation 7 may be omitted.

Operation 8: In operation 8, the first electronic device 601 may receive the onboarding payload from the second electronic device 602 and may transfer the received onboarding payload to the third electronic device 603. Accordingly, the first electronic device 601 and the third electronic device 603 may obtain the onboarding payload of the second electronic device 602.

### <UWB/BLE Onboarding Agent Operation Procedure 6050>

The UWB/BLE onboarding agent operation procedure 6050 may include operation 9 as follows.

Operation 9: In operation 9, the third electronic device 603 may apply the received onboarding payload. Accordingly, the third electronic device 603 may operate as a UWB/BLE onboarding agent. An example in which the third electronic device 603 operates as a UWB/BLE onboarding agent is described below with reference to FIG. 7.

FIG. 7 illustrates an initial connection and registration procedure of an IoT device according to another embodiment of the disclosure.

In the embodiment of FIG. 7, the first electronic device 701 may be the first electronic device 210a/b of FIG. 2A/B, the second electronic device 702 may be the second electronic device 220a/b of FIG. 2A/B, and the third electronic device 703 may be the third electronic device 230a/b of FIG. 2A/B. For example, the first electronic device 701 may be a smartphone of a new incoming user, the second electronic device 702 may be a washing machine WM, and the third electronic device 703 may be a first type smart tag SmartTag+ or a second type smart tag SmartTag++, but embodiments are not limited thereto.

In the embodiment of FIG. 7, the third electronic device 703 may be attached to the second electronic device 702.

In the embodiment of FIG. 7, the third electronic device 703 may operate as a UWB/BLE onboarding agent. The third electronic device 703 may start operating as a UWB/BLE onboarding agent, e.g., according to the embodiment of FIG. 6.

Referring to FIG. 7, the initial connection and registration procedure of the IoT device may include at least one of the following operations/procedures. According to an embodiment, some operations/procedures may be omitted, additional operations/procedures may be further performed, or operations/procedures may be performed in a different order from the disclosed order.

<BLE and/or UWB Connection Establishment Procedure 7010>

The BLE and/or UWB connection establishment procedure 7010 may be performed according to the above-described embodiments of FIGS. 3 to 4. For example, the BLE connection establishment procedure may include an operation in which the first electronic device 701 activates (or turns on the BLE module) a BLE discovery function, and the UWB connection procedure may include an operation in which the first electronic device 701 activates (or turns on the UWB module) a UWB listening function.

### <Onboarding Payload Acquisition Step 7020>

The onboarding payload acquisition procedure 7020 may include at least one of the following operations 1 to 4.
Operation 1: In operation 1, the first electronic device 701 may obtain data related to the gesture of the first electronic device 701. For example, a user guide for focusing the first electronic device 701 on the second electronic device 702 and taking a specific gesture to the first electronic device 701 (e.g., a user guide for dragging the first electronic device 701 in a body direction from the second electronic device 702) may be provided, and accordingly, when the user's gesture is taken, the first electronic device 701 may continuously receive/obtain UWB messages/data associated with the gesture. Accordingly, the first electronic device 701 may accumulate and obtain UWB-based information. As an embodiment, the UWB-based information may include at least one of ranging information, AoA information, or localization information.
Operation 2: In operation 2, the first electronic device 701 may identify the gesture based on the temporally accumulated UWB-based information.
Operation 3: In operation 3, the first electronic device 701 may transmit a request for obtaining the onboarding payload of the second electronic device 702 to the third electronic device 703 through the BLE connection. In an embodiment, when the identified gesture substantially matches the guided (or preset) gesture, the first electronic device 701 may transmit a request for obtaining the onboarding payload of the second electronic device 702 to the third electronic device 703 through the BLE connection.
Operation 4: In operation 4, the first electronic device 701 may receive the onboarding payload of the second electronic device 702 from the third electronic device 703 through UWB connection. As an embodiment, in response to the request of operation 3, the third electronic device 703 may transmit a UWB message (e.g., a UWB advertisement message (OWR message)) including the onboarding payload of the second electronic device 702 to the second electronic device 702.

As such, the new user device may easily obtain an onboarding payload of the IoT device based on a gesture through BLE and/or UWB connection with a tag device (e.g., a smart tag attached to the IoT device) without establishing a separate connection with the IoT device to be registered. This may lead to enhanced user experience.

### <Wi-Fi Connection Establishment Procedure 7030>

The Wi-Fi connection establishment procedure 7030 may be performed based on the Wi-Fi connection establishment procedure 5140 of FIG. 5 described above. For example, the Wi-Fi connection establishment procedure 7030 may include an operation in which the first electronic device 701 generates AP credential information (network connection information) for commissioning, an operation in which the first electronic device 701 transmits a request for applying the AP credential information to the Wi-Fi AP to the Wi-Fi AP, an operation in which the first electronic device 701 receives a response corresponding to the request from the Wi-Fi AP, an operation in which the first electronic device 701 transfers the AP credential information to the second electronic device 702, and/or an operation in which the second electronic device 702 connects to the Wi-Fi AP using the received AP credential information. Accordingly, a Wi-Fi connection between the second electronic device 702 and the Wi-Fi AP may be established. In other words, the second electronic device 702 may be connected to the IoT network.

### <Commissioning Step 7040>

The commissioning procedure 7040 may include operation 5 as follows.
Operation 5: In operation 5, the first electronic device 701 may discover the second electronic device 702 using the DNS-SD discovery scheme and may perform commissioning. As an embodiment, the first electronic device 701 may perform commissioning using a predefined method (e.g., a method defined in Matter specification).

For example, commissioning may include at least one of a password verification operation (first operation) between the first electronic device 701 and the second electronic device 702, an operation (second operation) in which the first electronic device 701 verifies the second electronic device 702, an operation (third operation) in which the first electronic device 701 transfers network connection information (e.g., an AP credential) to the second electronic device 702, an operation (fourth operation) in which the second electronic device 702 connects to a network (e.g., a Wi-Fi network) using network connection information (e.g., an AP credential), or an operation (fifth operation) in which the first electronic device 701 completes registration and network connection of the second electronic device 502. Meanwhile, when the Wi-Fi connection establishment procedure 7030 between the second electronic device 701 and the Wi-Fi AP 704 is performed before the commissioning procedure 7040, the third operation and the fourth operation described above may be omitted.

As an embodiment, when the Wi-Fi connection between the second electronic device 501 and the Wi-Fi AP 504 is not performed before the commissioning step 520, the first electronic device 501 may discover the second electronic device 502 using the BLE discovery scheme or the Soft-AP discovery scheme.

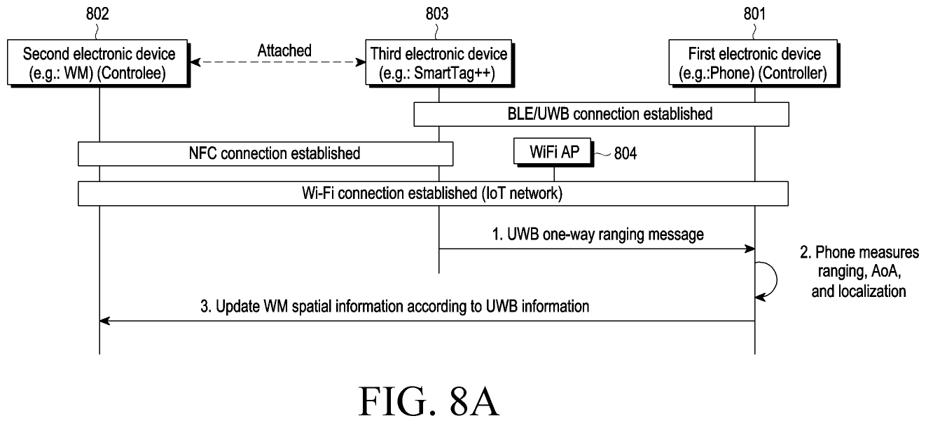

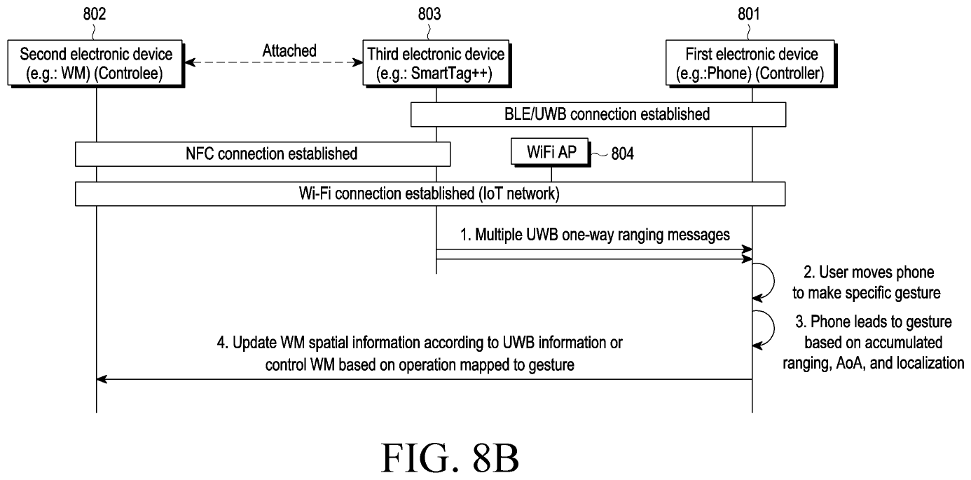

### [Control Procedure of IoT Device (Embodiment of FIGS. 8 to 11)]

FIG. 8A illustrates a control procedure of an IoT device according to an embodiment of the disclosure.

In the embodiment of FIG. 8A, the first electronic device 801 may be the first electronic device 210a of FIG. 2A, the second electronic device 802 may be the second electronic device 220a of FIG. 2A, and the third electronic device 803 may be the third electronic device 230a of FIG. 2A. For example, the first electronic device 801 may be the user's smartphone, the second electronic device 802 may be a washing machine WM, and the third electronic device 803 may be a second type smart tag SmartTag++, but embodiments are not limited thereto.

In the embodiment of FIG. 8A, the third electronic device 803 may be attached to the second electronic device 802, but embodiments are not limited thereto.

In the embodiment of FIG. 8A, it is assumed that the BLE and/or UWB connection between the first electronic device 801 and the third electronic device 803 is established, the NFC connection between the second electronic device 802 and the third electronic device 803 is established, and the Wi-Fi connection between the second electronic device 802 and the Wi-Fi AP 804 is established before the control procedure of the IoT device is performed.

Referring to FIG. 8A, the control procedure of the IoT device may include at least one of the following operations/procedures. According to an embodiment, some operations/procedures may be omitted, additional operations/procedures may be further performed, or operations/procedures may be performed in a different order from the disclosed order.
Operation 1: In operation 1, the first electronic device 801 may receive a UWB message for one-way ranging from the third electronic device 803. As an embodiment, after transmitting/receiving the UWB message for one-way ranging, the first electronic device 801 and the third electronic device 803 may exchange additional UWB messages for two-way ranging.
Operation 2: In operation 2, the first electronic device 801 may obtain UWB-based information (UWB info.) based on reception of the UWB message. As an embodiment, the UWB-based information may include at least one of ranging information, AoA information, or localization information.
Operation 3: In operation 3, the first electronic device 801 may update spatial information (spatial info.) about the second electronic device 802 based on UWB-based information. For example, the first electronic device 801 may transmit a request/command for updating spatial information about the second electronic device 802 to the second electronic device 802.

FIG. 8B illustrates a control procedure of an IoT device according to another embodiment of the disclosure.

In the embodiment of FIG. 8B, the first electronic device 801 may be the first electronic device 210a of FIG. 2A, the second electronic device 802 may be the second electronic device 220a of FIG. 2A, and the third electronic device 803 may be the third electronic device 230a of FIG. 2A. For example, the first electronic device 801 may be the user's smartphone, the second electronic device 802 may be a washing machine WM, and the third electronic device 803 may be a second type smart tag SmartTag++, but embodiments are not limited thereto.

In the embodiment of FIG. 8B, the third electronic device 803 may be the second electronic device 802, but embodiments are not limited thereto.

In the embodiment of FIG. 8B, unlike the embodiment of FIG. 8A, it is assumed that the first electronic device 801 receives a plurality of UWB messages from one third electronic device 803 using a temporal difference.

In the embodiment of FIG. 8B, it is assumed that the BLE and/or UWB connection between the first electronic device 801 and the third electronic device 803 is established, the NFC connection between the second electronic device 802 and the third electronic device 803 is established, and the Wi-Fi connection between the second electronic device 802 and the Wi-Fi AP 804 is established before the control procedure of the IoT device is performed.

Referring to FIG. 8B, the control procedure of the IoT device may include at least one of the following operations/procedures. According to an embodiment, some operations/procedures may be omitted, additional operations/procedures may be further performed, or operations/procedures may be performed in a different order from the disclosed order.
Operation 1: In operation 1, the first electronic device 801 may receive a plurality of UWB messages for one-way ranging from the third electronic device 803. As an embodiment, after transmitting/receiving the UWB message for one-way ranging, the first electronic device 801 and the third electronic device 803 may exchange additional UWB messages for two-way ranging.
Operation 2: In operation 2, the first electronic device 801 may be moved by the user to make a specific gesture.
Operation 3: In operation 3, the first electronic device 801 may identify the gesture based on the plurality of UWB-based information (accumulated UWB-based information) obtained based on the plurality of UWB messages. As an embodiment, the UWB-based information may include at least one of ranging information, AoA information, or localization information.
Operation 4: In operation 4, the first electronic device 801 may update spatial information (spatial info.) about the second electronic device 802 based on UWB-based information, and may control the second electronic device 802 based on an operation of mapping to a gesture. For example, the first electronic device 801 may update the spatial information about the second electronic device 802 and may transmit a request/command for controlling the second electronic device 802 to the second electronic device 802 based on the operation of mapping to the gesture.

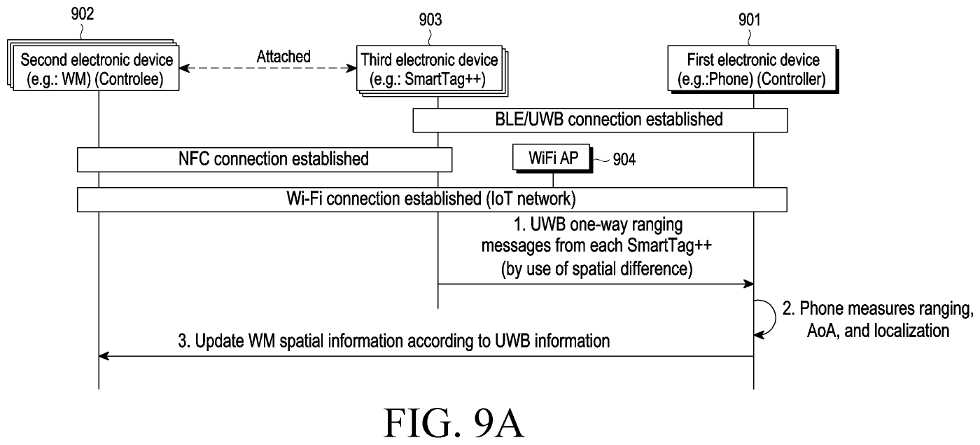

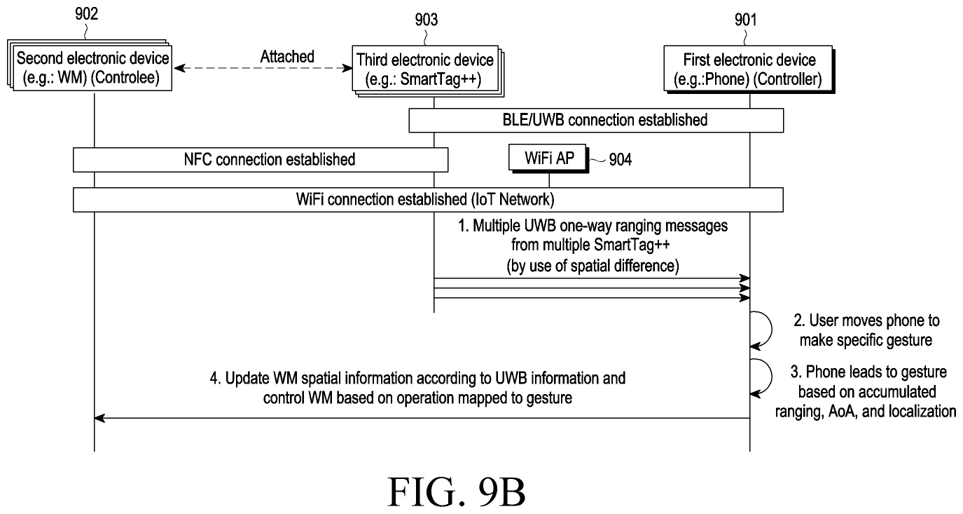

FIG. 9A illustrates a control procedure of an IoT device according to another embodiment of the disclosure.

In the embodiment of FIG. 9A, the first electronic device 901 may be the first electronic device 210a of FIG. 2A, the second electronic device 902 may be the second electronic device 220a of FIG. 2A, and the third electronic device 903 may be the third electronic device 230a of FIG. 2A. For example, the first electronic device 901 may be the user's smartphone, the second electronic device 902 may be a washing machine WM, and the third electronic device 903 may be a second type smart tag SmartTag++, but embodiments are not limited thereto.

In the embodiment of FIG. 9A, unlike the embodiment of FIG. 8A, it is assumed that there are a plurality of third electronic devices 903. In the embodiment of FIG. 9A, unlike the embodiment of FIG. 8A, it is assumed that the first electronic device 801 receives a plurality of UWB messages from the plurality of third electronic devices 803 using a spatial difference.

In the embodiment of FIG. 9A, the third electronic device 903 may be attached to the second electronic device 902, but embodiments are not limited thereto.

In the embodiment of FIG. 9A, it is assumed that the BLE and/or UWB connection between the first electronic device 901 and the third electronic device 903 is established, the NFC connection between the second electronic device 902 and the third electronic device 903 is established, and the Wi-Fi connection between the second electronic device 902 and the Wi-Fi AP 904 is established before the control procedure of the IoT device is performed.

Referring to FIG. 9A, the control procedure of the IoT device may include at least one of the following operations/procedures. According to an embodiment, some operations/procedures may be omitted, additional operations/procedures may be further performed, or operations/procedures may be performed in a different order from the disclosed order.
Operation 1: In operation 1, the first electronic device 901 may receive a UWB message for one-way ranging from each of the plurality of third electronic devices 903. As an embodiment, the first electronic device 901 may receive a UWB message for one-way ranging from each of the plurality of third electronic devices 903 using the spatial difference. As an embodiment, after transmitting/receiving the UWB message for one-way ranging, the first electronic device 901 and the third electronic device 903 may exchange additional UWB messages for two-way ranging.
Operation 2: In operation 2, the first electronic device 901 may obtain UWB-based information (UWB info.) based on reception of the plurality of UWB messages. As an embodiment, the UWB-based information may include at least one of ranging information, AoA information, or localization information.
Operation 3: In operation 3, the first electronic device 901 may update spatial information (spatial info.) about the second electronic device 902 based on UWB-based information. For example, the first electronic device 901 may transmit a request/command for updating spatial information about the second electronic device 902 to the second electronic device 902.

FIG. 9B illustrates a control procedure of an IoT device according to another embodiment of the disclosure.

In the embodiment of FIG. 9B, the first electronic device 901 may be the first electronic device 210a of FIG. 2A, the second electronic device 902 may be the second electronic device 220a of FIG. 2A, and the third electronic device 903 may be the third electronic device 230a of FIG. 2A. For example, the first electronic device 901 may be the user's smartphone, the second electronic device 902 may be a washing machine WM, and the third electronic device 903 may be a second type smart tag SmartTag++, but embodiments are not limited thereto.

In the embodiment of FIG. 9B, unlike the embodiment of FIG. 8A, it is assumed that there are a plurality of third electronic devices 903. In the embodiment of FIG. 9B, unlike the embodiment of FIG. 8A, it is assumed that the first electronic device 801 receives each of the plurality of UWB messages from the plurality of third electronic devices 803 using a temporal/spatial difference.

In the embodiment of FIG. 9B, the third electronic device 903 may be attached to the second electronic device 902, but embodiments are not limited thereto.

In the embodiment of FIG. 9B, it is assumed that the BLE and/or UWB connection between the first electronic device 901 and the third electronic device 903 is established, the NFC connection between the second electronic device 902 and the third electronic device 903 is established, and the Wi-Fi connection between the second electronic device 902 and the Wi-Fi AP 904 is established before the control procedure of the IoT device is performed.

Referring to FIG. 9B, the control procedure of the IoT device may include at least one of the following operations/procedures. According to an embodiment, some operations/procedures may be omitted, additional operations/procedures may be further performed, or operations/procedures may be performed in a different order from the disclosed order.
Operation 1: In operation 1, the first electronic device 901 may receive a plurality of UWB messages for one-way ranging from each of the plurality of third electronic devices 903. As an embodiment, the first electronic device 901 may receive a plurality of UWB messages for one-way ranging from each of the plurality of third electronic devices 903 using the spatial/temporal difference. As an embodiment, after transmitting/receiving the UWB message for one-way ranging, the first electronic device 901 and the third electronic device 903 may exchange additional UWB messages for two-way ranging.
Operation 2: In operation 2, the first electronic device 901 may be moved by the user to make a specific gesture.
Operation 3: In operation 3, the first electronic device 901 may identify the gesture based on the plurality of UWB-based information (accumulated UWB-based information) obtained based on the plurality of UWB messages. As an embodiment, the UWB-based information may include at least one of ranging information, AoA information, or localization information.
Operation 4: In operation 4, the first electronic device 901 may update spatial information (spatial info.) about the second electronic device 902 based on UWB-based information, and may control the second electronic device 902 based on an operation of mapping to a gesture. For example, the first electronic device 901 may update the spatial information about the second electronic device 902 and may transmit a request/command for controlling the second electronic device 902 to the second electronic device 902 based on the operation of mapping to the gesture.

FIG. 10 illustrates a control procedure of an IoT device according to another embodiment of the disclosure.

In the embodiment of FIG. 10, the first electronic device 1001 may be the first electronic device 210a of FIG. 2A, the 2-1th electronic device 1002-1 and the 2-2th electronic device 1002-2 may be the second electronic device 220a of FIG. 2A, and the third electronic device 1003 may be the third electronic device 230a of FIG. 2A. For example, the first electronic device 1001 may be the user's smartphone, the 2-1th electronic device 1002-1 may be a washing machine WM, the 2-2th electronic device 1002-2 may be a TV, and the third electronic device 1003 may be a second type smart tag SmartTag++, but embodiments are not limited thereto.

In the embodiment of FIG. 10, it is assumed that the third electronic device 1003 is attached to the 2-1th electronic device 1002-1.

### <Control Procedure of 2-1th Electronic Device 1002-1>

In the embodiment of FIG. 10, it is assumed that the BLE and/or UWB connection between the first electronic device 1001 and the third electronic device 1003 is established, the NFC connection between the 2-1th electronic device 1002-1 and the third electronic device 1003 is established, and the Wi-Fi connection between the 2-1th electronic device 1002-1 and the Wi-Fi AP 1004 is established before the control procedure of the 2-1th electronic device 1002-1 is performed.

Referring to FIG. 10, the control procedure of the 2-1th electronic device 1002-1 may include at least one of the following operations/procedures. According to an embodiment, some operations/procedures may be omitted, additional operations/procedures may be further performed, or operations/procedures may be performed in a different order from the disclosed order.
Operation 1: In operation 1, the first electronic device 1001 may receive a plurality of UWB messages for one-way ranging from each of the plurality of third electronic devices 1003. As an embodiment, the first electronic device 1001 may receive a plurality of UWB messages for one-way ranging from each of the plurality of third electronic devices 1003 using the spatial/temporal difference. As an embodiment, after transmitting/receiving the UWB message for one-way ranging, the first electronic device 1001 and the third electronic device 1003 may exchange additional UWB messages for two-way ranging.
Operation 2: In operation 2, the first electronic device 1001 may be moved by the user to make a specific gesture, and the first electronic device 1001 may identify the gesture based on the plurality of UWB-based information (accumulated UWB-based information) obtained based on the messages of the plurality of UWB messages. As an embodiment, the UWB-based information may include at least one of ranging information, AoA information, or localization information.
Operation 3: In operation 3, the first electronic device 1001 may update spatial information (spatial info.) about the 2-1th electronic device 1002-1 based on UWB-based information, and may control the 2-1th electronic device 1002-1 based on an operation of mapping to a gesture. For example, the first electronic device 1001 may update the spatial information about the 2-1th electronic device 1002-1, and may transmit a request/command for controlling the 2-1th electronic device 1002-1 to the 2-1 th electronic device 1002-1 based on the operation of mapping to the gesture.

### <Initial Connection/Registration Procedure of 2-2th Electronic Device 1002-2>

When there is a new 2-2th electronic device 1002-2 requiring registration, the first electronic device 1001 may perform an initial connection/registration procedure for the 2-2th electronic device 1002-2. The initial connection/registration procedure may include an onboarding payload acquisition procedure and/or a commissioning procedure.

In the embodiment of FIG. 10, for convenience of description, it is assumed that the 2-2th electronic device 1002-2 provides an onboarding payload through a QR code, but embodiments are not limited thereto.

The initial connection/registration procedure may include at least one of the following operations 4 to 7.
Operation 4: In operation 4, the first electronic device 1001 may initiate a camera by a user input and may initiate QR code-based onboarding.
Operation 5: In operation 5, the first electronic device 1001 may scan the QR code to read/obtain the onboarding payload of the 2-2th electronic device 1002-2.
Operation 6: In operation 6, the first electronic device 1001 may receive user identification for additional processing.

As an embodiment, before operation 6 (or operation 7), the 2-2th electronic device 1002-2 may establish a Wi-Fi connection with the Wi-Fi AP 1004. The Wi-Fi connection establishment procedure may be performed according to the Wi-Fi connection establishment procedure 5140 of FIG. 5 described above. For example, the Wi-Fi connection establishment procedure may include an operation in which the first electronic device 1001 generates AP credential information (network connection information) for commissioning, an operation in which the first electronic device 1001 transmits a request for applying the AP credential information to the Wi-Fi AP 1004 to the Wi-Fi AP 1004, an operation in which the first electronic device 1001 receives a response corresponding to the request from the Wi-Fi AP 1004, an operation in which the first electronic device 1001 transfers the AP credential information to the 2-2th electronic device 1002-2, and/or an operation in which the 2-2th electronic device 1002-2 connects to the Wi-Fi AP 1004 using the received AP credential information. Accordingly, a Wi-Fi connection between the 2-2th electronic device 1002-2 and the Wi-Fi AP 1004 may be established. In other words, the 2-2th electronic device 1002-2 may be connected to the IoT network.
Operation 7: In operation 7, the first electronic device 1001 may discover the 2-2th electronic device 1002-2 using the DNS-SD discovery scheme and perform commissioning. As an embodiment, the first electronic device 1001 may perform commissioning using a predefined method (e.g., a method defined in Matter specification).

### <Control Procedure of 2-2th Electronic Device 1002-2>

Referring to FIG. 10, the control procedure of the 2-2th electronic device 1002-2 may include at least one of the following operations/procedures. According to an embodiment, some operations/procedures may be omitted, additional operations/procedures may be further performed, or operations/procedures may be performed in a different order from the disclosed order.
Operation 8: In operation 8, the first electronic device 1001 may receive each of a plurality of UWB messages for one-way ranging (OWR) from each of the plurality of third electronic devices 1003. As an embodiment, the first electronic device 1001 may receive a plurality of UWB messages for one-way ranging from each of the plurality of third electronic devices 1003 using the spatial/temporal difference. As an embodiment, after transmitting/receiving the UWB message for one-way ranging, the first electronic device 1001 and the third electronic device 1003 may exchange additional UWB messages for two-way ranging.
Operation 9: In operation 9, the first electronic device 1001 may be moved by the user to make a specific gesture (e.g., a gesture of throwing toward the 2-2th electronic device 1002-2 while holding the first electronic device 1001), and the first electronic device 1001 may identify the gesture based on the plurality of UWB-based information (accumulated UWB-based information) obtained based on the plurality of UWB messages. As an embodiment, the UWB-based information may include at least one of ranging information, AoA information, or localization information.
Operation 10: In operation 10, the first electronic device 1001 may update spatial information (spatial info.) about the 2-2th electronic device 1002-2 based on UWB-based information, and may control the 2-2th electronic device 1002-2 based on an operation of mapping to a gesture. For example, the first electronic device 1001 may update the spatial information about the 2-2th electronic device 1002-2, and may transmit a request/command for controlling the 2-2th electronic device 1002-2 to the 2-2th electronic device 1002-2 based on the operation of mapping to the gesture.

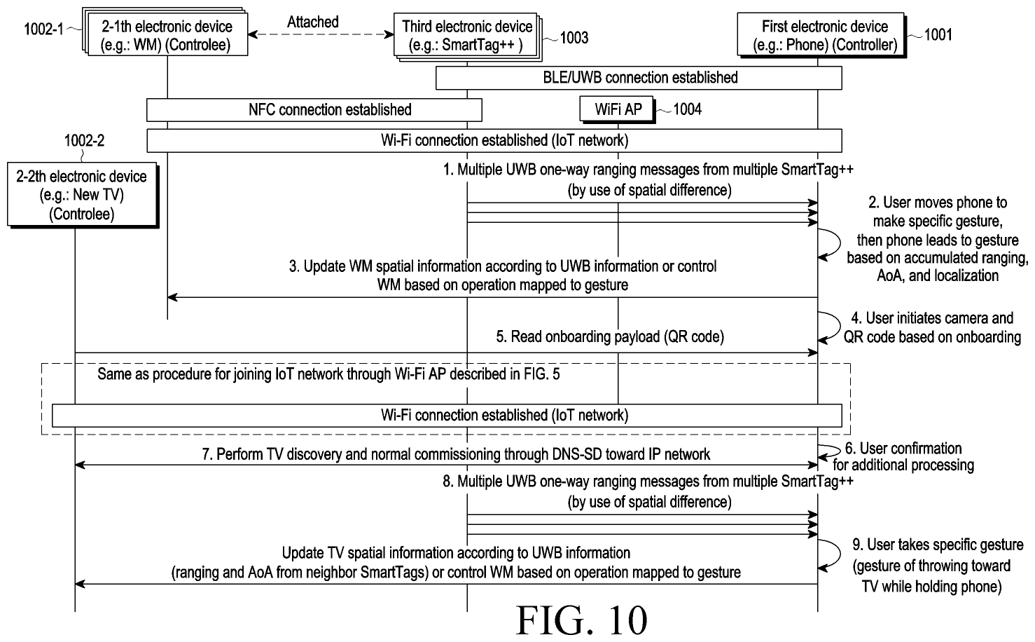

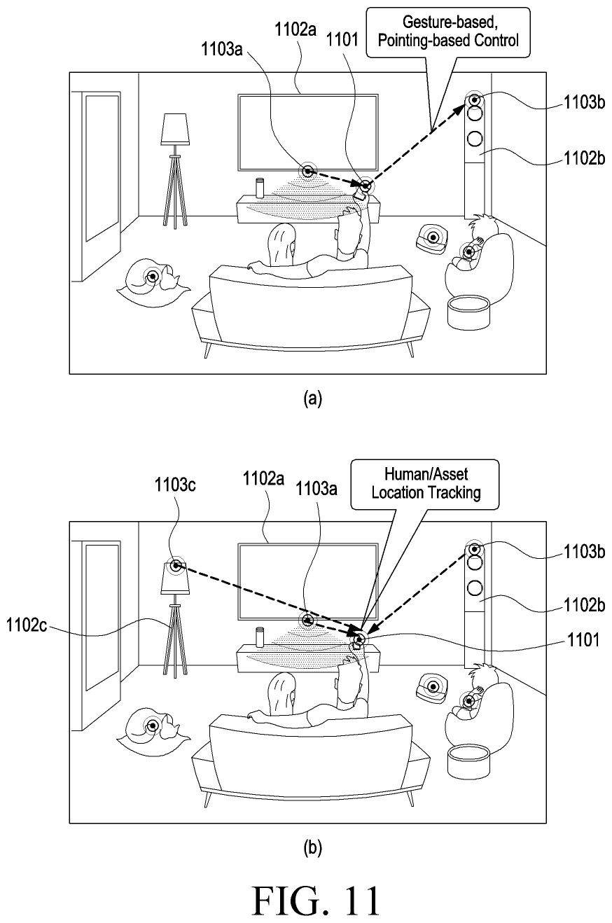

FIG. 11 illustrates a use example of controlling an IoT device using a smart tag according to an embodiment of the disclosure.

In the embodiments of FIG. 11, panels (a) and (b), the first electronic device 1101 may be the first electronic device 210a/b of FIG. 2A/B, the at least one second electronic device 1102a to 1102c may be the second electronic device 220a/b of FIG. 2A/B, and the at least one third electronic device 1103a to 1103c may be the third electronic device 230a/b of FIG. 2A/B. For example, as illustrated, the first electronic device 1101 may be the user's smartphone, the at least one second electronic device 1102a to 1102c may be a TV, an air conditioner AC, and/or lighting, and the at least one third electronic device 1103a to 1103c may be a first type smart tag SmartTag++ and/or a second type smart tag SmartTag++, but embodiments are not limited thereto.

In the embodiments of FIG. 11, panels (a) and (b), each of the third electronic devices 1103a to 1103c may be attached to a respective corresponding one of the second electronic devices 1102a to 1102c and may operate as an anchor for UWB one-way ranging.

As shown in FIG. 11, panel (a), the first electronic device 1101 may perform gesture-based and/or pointing-based control on a specific second electronic device 1102b using the at least one third electronic device 1103a to 1103b. Gesture-based and/or pointing-based control may follow the method described above in FIGS. 8 to 10.

As shown in FIG. 11, panel (b), the first electronic device 1101 may track the locations of the first electronic device 1101 and the user of the first electronic device 1101 using the at least one third electronic device 1103a to 1103c. Location tracking may follow the method described above with reference to FIGS. 8 to 10.

As in the embodiments of FIG. 11, panels (a) and (b), in the process of onboarding a new IoT device, when a specific gesture is taken after attaching a smart tag to the IoT device (e.g., when the specific gesture is taken with the smartphone brought to the smart tag or the smartphone oriented toward the IoT device), the IoT device may be onboarded and location information about the onboarded IoT device may be given based on UWB-based information. When location information about IoT devices onboarded in such a manner is given, high-precision indoor positioning of a target device (e.g., the user's smartphone) and/or the user of the target device is possible within the area of the IoT network. For example, smart tags attached to the IoT device given the location information may operate as anchors of the down-link (DL) TDoA for measuring the location of the target device/user, and OWR messages for the DL-TDoA may be exchanged therebetween.

Meanwhile, for another IoT device to which a smart tag is not attached, an onboarding procedure may be performed through a conventional method such as a QR code method, and the user's smartphone may be brought in contact with the corresponding IoT device, thereby updating the location information. In this case, it is possible to control the corresponding IoT device to which a smart tag is not attached through UWB-based gesture recognition through an ambient smart tag-attached IoT device.

According to an embodiment of the disclosure, it is possible to provide the user with an advanced onboarding experience (UX) along with a spatial information update of the IoT device as compared with the conventional QR code/camera-based onboarding process by supporting UWB/BLE-based onboarding process and UWB-based control on the IoT device.

According to an embodiment of the disclosure, it is possible to provide the user with easy pointing, gesture, motion recognition-based IoT device control using UWB-based information by supporting UWB-based control on the IoT device.

According to an embodiment of the disclosure, it is possible to deploy a UWB/BLE interface for an IoT network in a simplified and low-cost manner by attaching attachable UWB/BLE supporting smart tags to IoT devices.

According to an embodiment of the disclosure, it is possible to obtain UWB-based information through UWB ranging with adjacent devices and easily perform location tracking on the target device or the user of the target device based thereon.

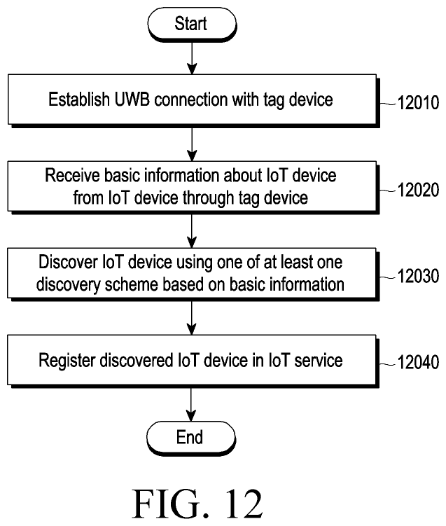

FIG. 12 illustrates a method of an electronic device according to an embodiment of the disclosure.

In the embodiment of FIG. 12, the electronic device may be the first electronic device 210a/b of FIG. 2A/B, the IoT device may be the second electronic device 220a/b of FIG. 2A/B, and the tag device may be the third electronic device 230a/b of FIG. 2A/B.

The electronic device may establish a UWB connection with the tag device (12010).

The electronic device may receive basic information about the IoT device from the IoT device through the tag device (12020).

Based on the basic information, the electronic device may discover the IoT device using one of at least one discovery scheme (12030).

The electronic device may register the discovered IoT device in the IoT service (12040).

As an embodiment, the method may further include transmitting network connection information for network connection to the IoT device through the tag device, and discovering the IoT device may include: discovering the IoT device connected to the network using the network connection information using a first discovery scheme among the at least one discovery scheme.

As an embodiment, the first discovery scheme may be a domain name service (DNS)-service discovery (SD) discovery scheme.

As an embodiment, an NFC connection between the tag device and the IoT device may be established.

As an embodiment, the method may further comprise receiving at least one UWB message from the tag device through the UWB connection.

As an embodiment, the method may further comprise identifying a gesture of the electronic device, based on the at least one UWB message and transmitting a command to perform an operation corresponding to the gesture to the IoT device.

As an embodiment, the method may further comprise updating spatial information about the IoT device based on the at least one UWB message.

As an embodiment, the at least one UWB message may be a UWB message for one-way ranging (OWR).

As an embodiment, the UWB message for one-way ranging may be a UWB advertisement message for an advertisement, and the UWB advertisement message may include basic information about the IoT device.

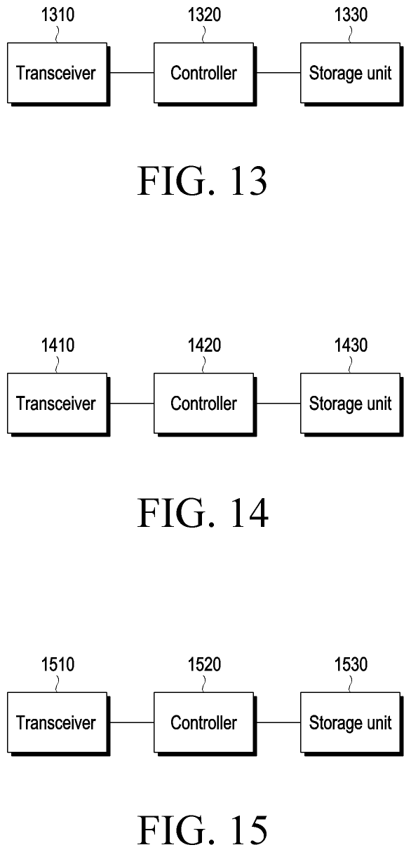

FIG. 13 is a view illustrating a structure of a first electronic device according to an embodiment of the disclosure.

In the embodiment of FIG. 13, the first electronic device may be, e.g., the first electronic device 210a/b of FIG. 2A/B.

Referring to FIG. 13, the first electronic device may include a transceiver 1310, a controller 1320, and a storage 1330. In the disclosure, the controller may be defined as a circuit or application-specific integrated circuit or at least one processor.

The transceiver 1310 may transmit and receive signals to/from other network entities. The transceiver 1310 may transmit/receive data for commissioning.

The controller 1320 may control the overall operation of the electronic device according to an embodiment. For example, the controller 1320 may control inter-block signal flow to perform the operations according to the above-described flowchart. Specifically, the controller 1320 may control the operations of the electronic device described above with reference to FIGS. 1 to 12.

The storage unit 1330 may store at least one of information transmitted/received via the transceiver 1310 and information generated via the controller 1320. For example, the storage unit 1330 may store information and data necessary for commissioning described above with reference to FIGS. 1 to 12.

FIG. 14 is a view illustrating a structure of a second electronic device according to an embodiment of the disclosure; and

In the embodiment of FIG. 14, the second electronic device may be, e.g., the second electronic device 220a/b of FIG. 2A/B.

Referring to FIG. 14, the second electronic device may include a transceiver 1410, a controller 1420, and a storage 1430. In the disclosure, the controller may be defined as a circuit or application-specific integrated circuit or at least one processor.

The transceiver 1410 may transmit and receive a signal to and from another device. The transceiver 1410 may transmit/receive data for commissioning.

The controller 1420 may control the overall operation of the commissionee device according to an embodiment. For example, the controller 1420 may control inter-block signal flow to perform the operations according to the above-described flowchart. Specifically, the controller 1420 may control the operations of the commissionee device described above with reference to FIGS. 1 to 12.

The storage unit 1430 may store at least one of information transmitted/received via the transceiver 1410 and information generated via the controller 1420. For example, the storage unit 1430 may store information and data necessary for commissioning described above with reference to FIGS. 1 to 12.

FIG. 15 is a view illustrating a structure of a third electronic device according to an embodiment of the disclosure.

In the embodiment of FIG. 15, the third electronic device may be, e.g., the third electronic device 230a/b of FIG. 2A/B.

Referring to FIG. 15, the third electronic device may include a transceiver 1510, a controller 1520, and a storage 1530. In the disclosure, the controller may be defined as a circuit or application-specific integrated circuit or at least one processor.

The transceiver 1510 may transmit and receive a signal to and from another device. The transceiver 1510 may transmit/receive data for commissioning.

The controller 1520 may control the overall operation of the auxiliary device according to an embodiment. For example, the controller 1520 may control inter-block signal flow to perform the operations according to the above-described flowchart. Specifically, the controller 1520 may control the operations of the commissionee device described above with reference to FIGS. 1 to 12.

The storage unit 1530 may store at least one of information transmitted/received via the transceiver 1510 and information generated via the controller 1520. For example, the storage unit 1530 may store information and data necessary for commissioning described above with reference to FIGS. 1 to 12.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method for connecting an Internet of things (IoT) device to an IoT service and controlling, using a tag device, by an electronic device, the method comprising:
establishing a UWB connection with the tag device;
receiving basic information about the IoT device from the IoT device through the tag device;
discovering the IoT device using one of at least one discovery scheme based on the basic information; and
registering the discovered IoT device in the IoT service.

2. The method of claim 1, further comprising transmitting network connection information for network connection to the IoT device through the tag device, wherein discovering the IoT device includes discovering the IoT device connected to the network using the network connection information, using a first discovery scheme among the at least one discovery scheme.

3. The method of claim 2, wherein the first discovery scheme is a domain name service (DNS)-service discovery (SD) discovery scheme.

4. The method of claim 1, wherein an NFC connection is established between the tag device and the IoT device.

5. The method of claim 3, further comprising receiving at least one UWB message from the tag device through the UWB connection.

6. The method of claim 5, further comprising:
identifying a gesture of the electronic device based on the at least one UWB message; and
transmitting a command to perform an operation corresponding to the gesture to the IoT device.

7. The method of claim 5, further comprising updating spatial information about the IoT device based on the at least one UWB message.

8. The method of claim 5, wherein the at least one UWB message is a UWB message for one-way ranging (OWR).

9. The method of claim 8,
wherein the UWB message for one-way ranging is a UWB advertisement message for advertisement, and
wherein the UWB advertisement message includes basic information about the IoT device.

10. An electronic device for connecting an Internet of things (IoT) device to an IoT service and controlling, using a tag device, the electronic device comprising:
a transceiver; and
a controller connected to the transceiver, wherein the controller is configured to:
establish a UWB connection with the tag device,
receive basic information about the IoT device from the IoT device through the tag device,
discover the IoT device using one of at least one discovery scheme based on the basic information, and
register the discovered IoT device in the IoT service.

11. The electronic device of claim 10,
wherein the controller is further configured to:
transmit network connection information for network connection to the IoT device through the tag device, and
wherein discovering the IoT device includes:
discover the IoT device connected to the network using the network connection information, using a first discovery scheme among the at least one discovery scheme.

12. The electronic device of claim 11, wherein the first discovery scheme is a domain name service (DNS)-service discovery (SD) discovery scheme.

13. The electronic device of claim 11, wherein an NFC connection is established between the tag device and the IoT device.

14. The electronic device of claim 10, wherein the controller is further configured to receive at least one UWB message from the tag device through the UWB connection.

15. The electronic device of claim 14, wherein the controller is further configured to:
identify a gesture of the electronic device based on the at least one UWB message; and
transmit a command to perform an operation corresponding to the gesture to the IoT device.
